(19) United States
(12) Patent Application Publication
(10) Pub. No.: US 2012/0139190 A1
(43) Pub. Date: Jun. 7, 2012

(54) RING SEAL RETAINER ASSEMBLY AND METHODS

(75) Inventor: Gregory M. Doyle, Orange, CA (US)

(73) Assignee: MICROFLEX TECHNOLOGIES, LLC, Anaheim, CA (US)

(21) Appl. No.: 13/312,156

(22) Filed: Dec. 6, 2011

Related U.S. Application Data
(60) Provisional application No. 61/420,268, filed on Dec. 6, 2010.

(51) Int. Cl. F16J 15/02; B23P 11/02

(52) U.S. Cl. 277/639; 277/641; 29/446

(57) ABSTRACT

A retainer for a gasket used to connect modular piping in a modular gas delivery system to the gas flow controlling components protects the sealing surface of the gasket from scratches before assembly by suspending the gasket at least 0.003 inches inside the retainer, regardless of orientation. Additionally, a slit in the circumference of the retainer allows the retainer to flex open for insertion of the seal gasket, and to compress to a smaller circumference, for a tight fit inside the sealing counterbore. A chamfer on the ID of the retainer aids the easier insertion of the seal into the retainer. In the ID of the retainer, a groove engages a protruding portion of the seal. The depth of this groove is such that with a complete compression of the retainer where the circumferential gap is completely closed, the protruding edge of the seal still has some clearance. This clearance acts as a stop to prevent the retainer from being overly compressed.

This application claims the benefit under 35 U.S.C. 119(e) of the filing date of Provisional U.S. Application Ser. No. 61/420,268, entitled Ring Seal Retainer Assembly and Methods, filed on Dec. 6, 2010, which is commonly assigned herewith and herein expressly incorporated herein by reference, in its entirety.

### FIELD OF THE INVENTION

This invention relates generally to fluid couplings and more particularly to fluid couplings having seal assemblies including flexible gaskets and flexible retainers for those gaskets.

### BACKGROUND OF THE INVENTION

Ring seals are typically annularly shaped, defining an axially aligned hole for gas or fluid passage, two axially opposed end surfaces, a radial inner surface and a radially outer surface. A simplistic ring seal has planar end surfaces and smooth circular radial inner and outer surfaces which define the inner diameter (ID) and outer diameter (OD) of the ring seal. However, it is common practice in the industry to utilize seals having different radial cross-sections to obtain varying sealing capabilities for different fluid flow environments.

A commonly used ring seal is circular and has a radial cross-section of a “C” shape. These “C seals” are constructed with the open side of the C construction facing the center of the ring such as is described in U.S. Pat. No. 5,354,072, or with the open side of the C facing away from the center of two mating surfaces are brought together with the C seal in the middle, the C seal is compressed with the open side of the C cross-section closing during compression. The ductile properties of the seal permit plastic deformation to occur without damaging the mating surfaces.

Additional seals which have been available include “V” seals which are also circular, but instead of having a “C” cross-section, have a “V” cross-section with the low point of the V constructed to point either inwardly or outwardly towards the center of the seal. Other seals known in the art include “Z” seals and simple 0-rings. These other types of seals are discussed, for example, in U.S. Pat. No. 6,708,985. Both of the '072 and '985 patents are herein expressly incorporated by reference, in their entirety.

Still another type of ring seal known in the industry is the “W”-seal type face seal, particularly adapted for use in surface mount gas panels. Such a sealing system is disclosed, for example, in U.S. Pat. No. 7,140,647, also herein expressly incorporated by reference, in its entirety. The “W” seal in the '647 patent uses a snap ring situated on the inside of a retaining ring, identified in the patent as a guide, to retain the W-seal in the retainer and to keep the sealing surfaces on the W-seal or gasket protected from scratches. The '647 patent retainer or guide also has a snap ring situated on its outside diameter to keep the retainer engaged in the counterbore.

FIGS. 1-4 illustrate a typical prior art “W” seal 2, comprising a retainer sleeve 2a, and a metal seal 2b. As discussed above, the assembly 2 further comprises an interior snap ring 2c and an exterior snap ring 2d. To accommodate these snap rings, there is provided a first Outside Diameter (OD) groove 2e on the outer surface of the retainer sleeve 2a, and an Inside Diameter (ID) groove 2f on the inner surface of the retainer sleeve 2a. Additionally, a second OD groove 2g is provided on the outer surface of the metal seal 2b, which corresponds to the ID groove 2f, wherein the second OD groove 2g and the ID groove 2f together accommodate the interior snap ring 2c. It should be noted that the cut in the ring and seal shown in FIG. 2 is illustrative only, for the purpose of illustrating particular constructional features of the seal assembly. In actuality, both the seal and the retaining ring are circumferentially continuous and unbroken.

Thus, each prior art W-seal requires four separate parts, including two snap rings, and three formed grooves for accommodating those snap rings, resulting in manufacturing complexity and relatively high cost. Additionally, these snap rings have often been found to make it substantially more difficult to remove the seal from the counterbore when desired, causing productivity problems, and sometimes damage to the seal assembly. Another reason why these types of seals often stick in the counterbore when it is desired to remove them is because the seal is a thick VCR gasket, and tends to compress when expanded, thus causing the retainer to also expand.

There are other problems with prior art ring seals of this type. These problems include the seal sometimes pushing the bead over, causing a leak due to high load, as well as the seal tending to move off-center. The off-center problem is often related to a build-up of tolerances because of the multiple parts, including the two snap rings, as well as over-compression of the snap ring, which causes the round retainer to distort into an oval or ellipse, thus forcing the seal off-center.

What is needed, for above described sealing system applications, is a face seal system which affords certain functional advantages without the necessity and expense involved in employing snap rings, and which is preferably constructed to permit easy removal from the counterbore.

### SUMMARY OF THE INVENTION

The present invention addresses the issues noted above, by providing a ring sealing system suitable for applications such as a semiconductor manufacturing modular gas delivery system.

Specifically, the inventive sealing system comprises a retainer for a gasket used to connect modular piping in a modular gas delivery system to the gas flow controlling components. The retainer design protects the polished sealing surface of the W-seal gasket from scratches before assembly by suspending the gasket at least 0.003 inches inside the retainer, regardless of orientation. Additionally, a slit or gap in the circumference of the retainer allows the retainer to flex open for insertion of the W-seal gasket. A small chamfer on the ID of the retainer, in certain embodiments, aids the easier insertion of the W-seal into the retainer.

The gap in the circumference of the retainer also allows the retainer to compress to a smaller circumference, for a tight fit inside the sealing counterbore. In the ID of the retainer, there is a groove machined for a protruding portion of the W-seal to engage. The depth of this groove is such that with a complete compression of the retainer where the circumferential gap is completely closed, the protruding edge of the W-seal still has some clearance. This clearance, which acts as a stop to prevent the retainer from being overly compressed, insures that the seal and retainer assembly will not jam while trying to insert the assembly into the counterbore.

The slit or gap in the circumference of the retainer allows for a larger tolerance in the machining on the OD of the retainer. With current designs, a slightly oversized OD will prevent insertion of the retainer and seal assembly into the counterbore because there is no room for compression. In the inventive design, the retainer is free to close up to 0.010 inches as currently manufactured. The gap in the circumference can be made larger and achieve the same results.

There is a slight chamfer around the OD of the retainer for easier location of the retainer on the counterbore. The top half of the retainer has a slightly smaller OD for easy alignment of surface mount components. This is especially important for components with multiple sealing points that engage on the same block.

An additional advantageous feature of the present invention is the employment of a chamfer on at least one outside corner of the annular retaining member for easing installation of the retaining member into a counterbore. A chamfer may also be disposed on at least one inside corner of the annular retaining member for easing insertion of the sealing member into the retaining member. Yet another advantageous feature of the invention is the inclusion of a load adjustment groove disposed on the ID of the seal member, for substantially improving the elastic response of the seal.

More particularly, there is provided a ring seal assembly which comprises an annular metal seal having an ID, an OD, an upper sealing surface, and a lower sealing surface, wherein the OD comprises a larger OD portion and a smaller OD portion. An annular metal retaining ring is also provided, comprising an outer wall having an ID and OD, wherein the ID of the retaining ring is sufficiently large to accommodate the OD of the annular metal seal within its boundaries. Advantageously, the ID of the retaining ring has a groove disposed therein which is circumferentially arranged to receive the larger OD portion of the annular metal seal. The larger OD portion of the seal comprises metal, and extends radially into the groove and the remaining ID portion of the retaining ring bounding the smaller OD portion of the seal.

The retaining ring is circumferentially compressible to a reduced circumferential size. The compressibility arises because a gap exists between at least a portion of the circumference of the retaining ring and a corresponding portion of the circumference of the seal when the retaining ring is in a relaxed state and thus at its full natural circumferential size. This gap permits the retaining ring to be compressed without impacting the seal.

A split is disposed through at least a portion of the retaining ring at a particular circumferential location thereon to provide the retaining ring with its circumferential compressibility. In one illustrated embodiment, this split extends upwardly from a bottom edge of the retaining ring through only the larger OD portion of the retaining ring. Preferably, a plurality of these partial splits are circumferentially spaced about said retaining ring. In other embodiments a single split extends upwardly through the entire height of the circumferential wall defining the retaining ring.

The section of the retaining ring outer wall defining the larger ID portion is relatively thick and the section of the retaining ring outer wall defining the smaller ID portion is relatively thin. In certain inventive embodiments, the OD of the retaining ring is substantially uniform, while in others, the OD of the retaining ring comprises a smaller OD portion and a larger OD portion. In still another illustrated embodiment, a removal groove is disposed in the smaller retaining ring OD portion. This removal groove assists in visually determining the proper orientation of the seal assembly in the counterbore, and preferably groove forms a radially-oriented ledge for assisting in removal of the assembly from a counterbore.

The OD of the seal preferably comprises a load adjusting feature. This load adjusting feature may comprise a groove extending circumferentially about the OD of the seal, or it may comprise a plurality of circumferentially spaced bores. The circumferentially spaced bores may form a single row between the smaller OD portion and the larger OD portion of the seal, or may form a row on the smaller OD portion of the seal and a second row on the larger OD portion of the seal.

An important feature of the present invention is the provision of a chamfer on at least one inside corner of the retaining ring for easing insertion of the sealing member into the retaining member. A second chamfer may be disposed on at least one outside corner of the retaining ring, and even more advantageously, a chamfer or angled step may be provided on the larger OD portion of the seal for engaging the chamfer on the retaining ring.

The inventive seal assembly does not have any snap rings, an important advantage over prior art approaches.

In another aspect of the invention, there is provided a ring seal assembly, which comprises an annular seal member having an inner diameter (ID) and an outer diameter (OD), and having an axial hole defined by the ID for fluid passage, wherein the OD of the seal member comprises a smaller OD portion and a larger OD portion. An annular retaining member is also provided, having an ID and an OD, wherein the ID of the retaining member is larger than the OD of the seal member. A chamfer is provided on at least one inside corner of the annular retaining member for easing insertion of the sealing member into the retaining member. The OD of the seal member comprises a smaller OD portion and a larger OD portion and the ID of the retaining member comprises an axially cylindrical first portion and a second portion comprising a groove extending radially outwardly of the first portion for receiving and accommodating the larger OD portion of the seal, which extends radially outwardly into the groove.

In its assembled state, with the seal disposed within the ID of the retaining ring, there is a gap between the seal and the retaining ring about a portion of the circumference of the assembly, to thereby permit compression of the retaining ring without substantial contact of the retaining ring with the seal. In one embodiment, the OD of the retaining ring comprises a smaller OD portion and a larger OD portion. A recess is disposed between an annular edge of the retaining ring and one of the upper and lower sealing surfaces of the sealing ring when the seal assembly is in an assembled state, the recess functioning to protect the one of the upper and lower sealing surfaces from inadvertent contact damage. A second recess is disposed between an opposing annular edge of the retaining ring and the other of the upper and lower sealing surfaces of the sealing ring when the seal assembly is in the assembled state, to thereby protect the other of the upper and lower sealing surfaces from inadvertent contact damage.

Advantageously, the inventive assembly does not have any snap rings.

In still another aspect of the invention, there is provided a fluid coupling which comprises a base block, a component, wherein the component is assembled to the base block, and a fluid flow passage extending through the assembled base block and component. A counterbore is disposed in the fluid passage and extends radially outwardly into the assembled base block and component, wherein each of the base block and component have a sealing bead extending into the counterbore for engaging a seal. A ring seal assembly is disposed in the fluid flow passage, and comprises an annular metal seal having an ID, an OD, an upper sealing surface, and a lower sealing surface. The OD comprises a larger OD portion and a smaller OD portion. An annular metal retaining ring comprises an outer wall having an ID and OD, wherein the ID of the retaining ring is sufficiently large to accommodate the OD of the annular metal seal within its boundaries. The ID of the retaining ring has a groove disposed therein which is circumferentially arranged to receive the larger OD portion of the annular metal seal. The larger OD portion of the seal comprises metal and extends radially into the groove and the remaining ID portion of the retaining ring bounding the smaller OD portion of the seal. The ring seal assembly is secured into the counterbore such that the sealing beads engage the annular metal seal to seal the joint between the base block and the component.

In yet another aspect of the invention, there is disclosed a method of assembling a resilient retaining ring and an annular seal, wherein the retaining ring comprises a chamfered edge. The method comprises a step of engaging the seal against the chamfered edge to expand the retaining ring, and a further step of sliding the seal into engagement with a groove on an ID surface of the retaining ring. Another step is that of permitting the retaining ring to expand circumferentially to seat and center the seal.

The invention, together with additional features and advantages thereof, may be best understood by reference to the following description taken in conjunction with the accompanying illustrative drawings. In these accompanying drawings, like reference numerals designate like parts throughout the figures.

### BRIEF DESCRIPTION OF THE DRAWINGS

FIG. 1 is an isometric view of a prior art W-seal;

FIG. 2 is an isometric view of the W-seal shown in FIG. 1, wherein a circumferential portion has been removed to illustrate a cross-section of the seal;

FIG. 3 is a cross-sectional view of the prior art W-seal shown in FIGS. 1 and 2;

FIG. 4 is an exploded view of the prior art W-seal shown in FIGS. 1-3;

FIG. 5 is a top view of one embodiment of a retaining ring constructed in accordance with the principles of the present invention;

FIG. 6 is a cross-sectional view of the retaining ring shown in FIG. 5;

FIG. 7 is a detailed cross-sectional view of the portion of FIG. 6 denoted by the letter A;

FIG. 8 is an isometric view of the retaining ring of FIGS. 5-7;

FIG. 9 is a top view of a modified embodiment of the retaining ring of the present invention;

FIG. 10 is a cross-sectional view of the retaining ring shown in FIG. 9;

FIG. 11 is a detailed cross-sectional view of the portion of FIG. 10 denoted by the letter B;

FIG. 12 is an isometric view of the retaining ring of FIGS. 9-11;

FIG. 13 is a top view of an embodiment of a sealing gasket constructed in accordance with the principles of the present invention;

FIG. 14 is an elevation of the gasket shown in FIG. 13;

FIG. 15 is a cross-sectional view of the gasket shown in FIGS. 13 and 14;

FIG. 16 is a detailed cross-sectional view of the portion of FIG. 15 denoted by the letter C;

FIG. 17 is an isometric view of the gasket shown in FIGS. 13-16;

FIG. 18 is a top view of a modified embodiment of a sealing gasket according to the present invention;

FIG. 19 is an isometric view of the gasket shown in FIG. 18;

FIG. 20 is an elevation of the gasket shown in FIGS. 18 and 19;

FIG. 21 is a cross-sectional view of the gasket illustrated in FIGS. 18-20;

FIG. 22 is an isometric view of a modified embodiment of a retaining ring forming a part of the seal ring assembly of the present invention;

FIG. 23 is an isometric view of a seal ring assembly of the present invention, shown using the retaining ring illustrated in FIG. 12, for exemplary purposes;

FIG. 24 is an elevation of another modified embodiment of a sealing gasket according to the present invention;

FIG. 25 is an elevation of yet another modified embodiment of a sealing gasket according to the present invention;

FIG. 25a is an elevation of still another modified embodiment of a sealing gasket according to the present invention;

FIG. 26 is a cross-sectional view illustrating the retaining ring and gasket assembly shown in FIG. 23, for exemplary purposes;

FIG. 27 is a cross-sectional view similar to FIG. 26 illustrating an assembled seal, according to the invention, after it has been fully installed and compressed to its operational status;

FIG. 28 is a top view of a fluid flow system in which the inventive seal assembly of the present invention has been installed;

FIG. 29 is a cross-sectional view taken through lines 29-29 of FIG. 28;

FIG. 30 is a cross-sectional view taken through lines 30-30 of FIG. 29;

FIG. 31 is an exploded isometric view of the fluid sealing system shown in FIGS. 28-30;

FIG. 32 is an enlarged exploded isometric view of the portion of the system illustrated in FIG. 31 which is denoted by the letter E;

FIG. 33 is an exploded isometric view similar to FIG. 31, showing the seal in an assembled state; and

FIG. 34 is an enlarged exploded isometric view of the portion of the system illustrated in FIG. 33 which is denoted by the letter F.

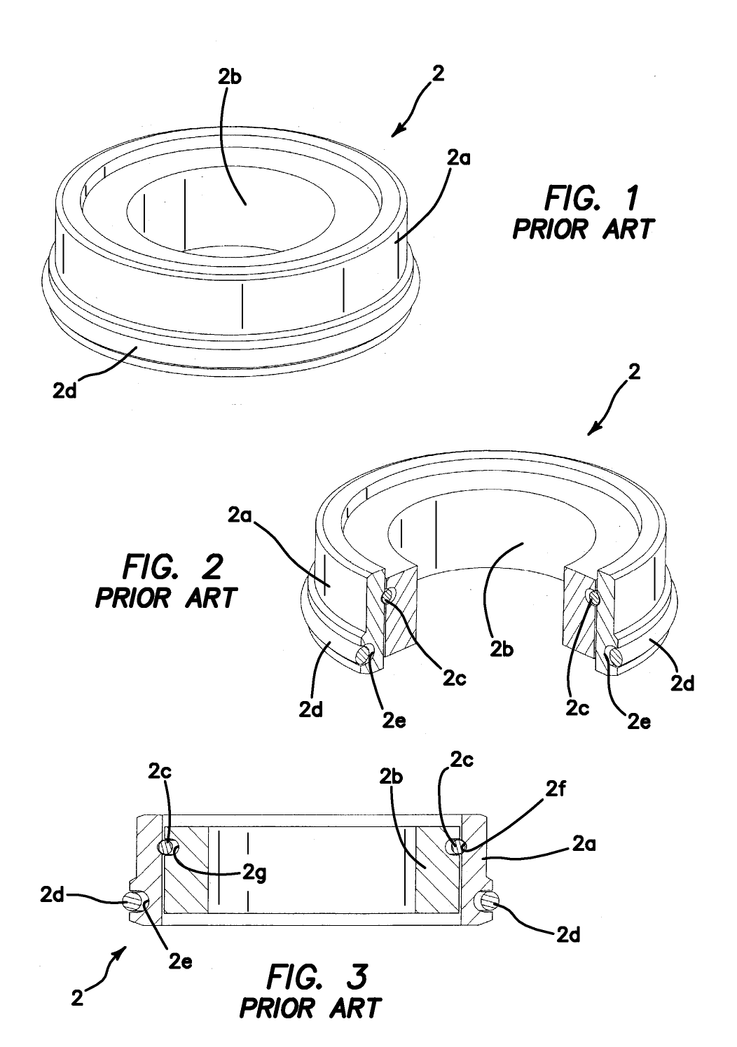

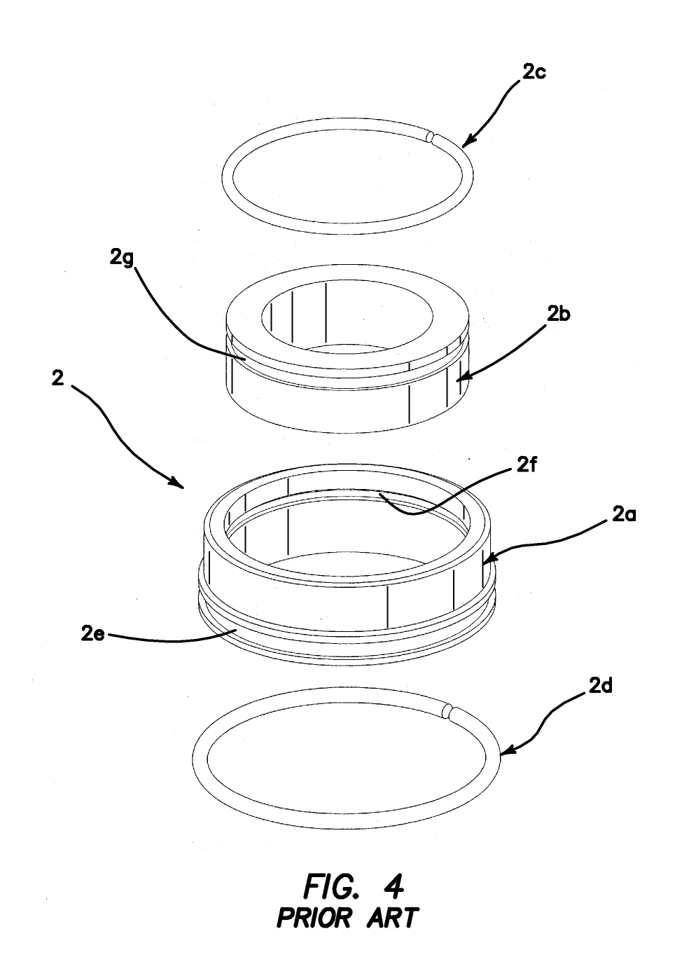

### DETAILED DESCRIPTION OF THE INVENTION

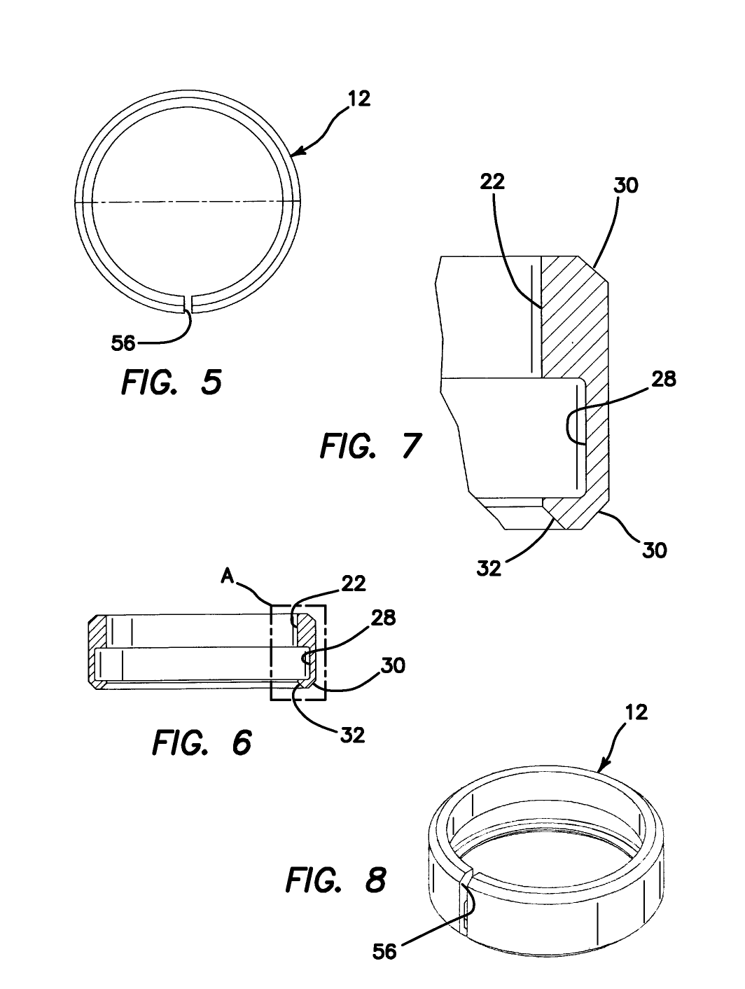

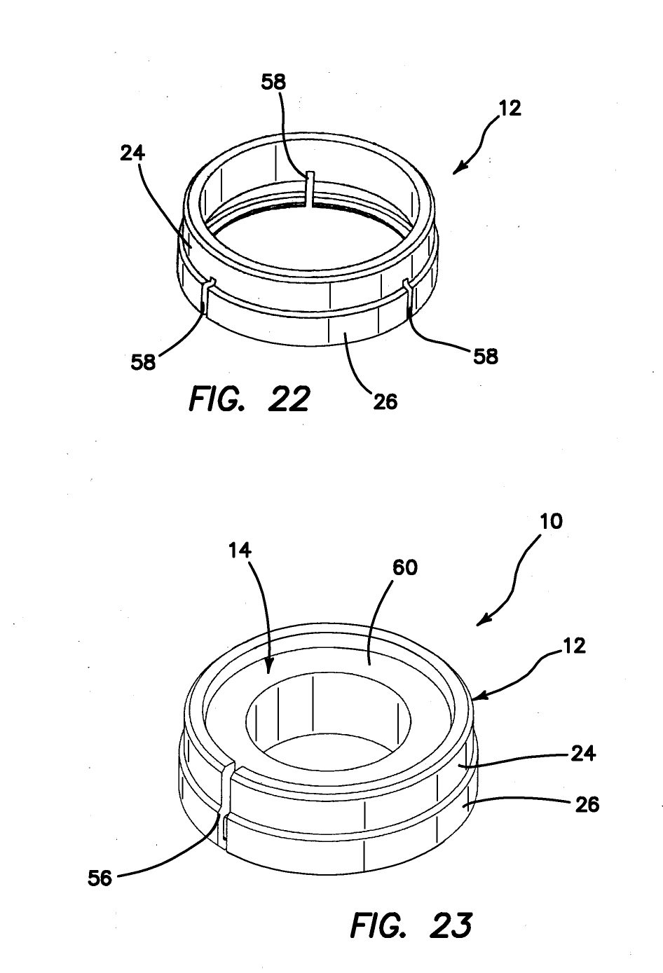

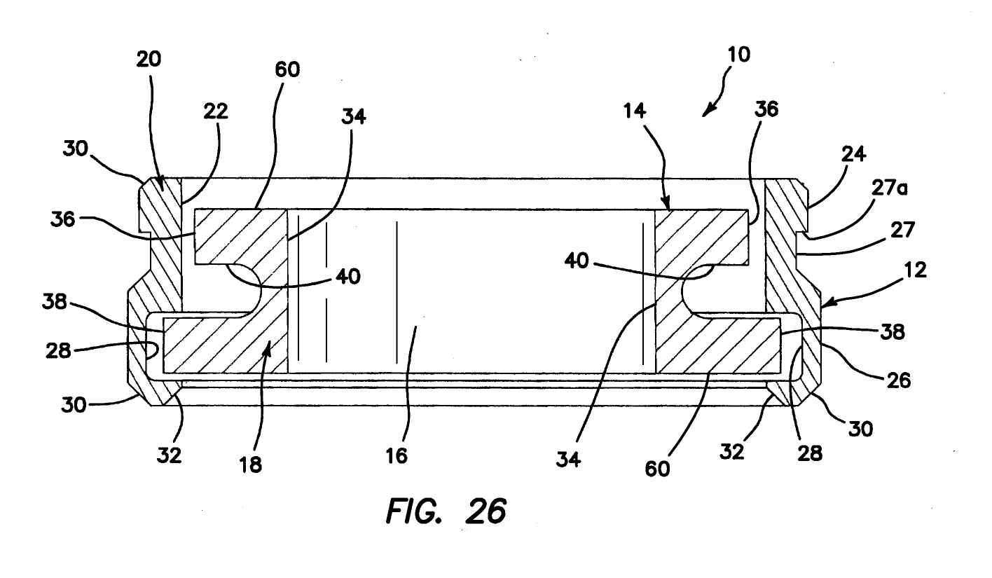

Referring now more particularly to FIGS. 5-34, wherein like reference numerals designate identical or corresponding parts throughout the several views and embodiments, and the terms “lower” and “upper” are with respect to the figures only, and not necessarily with the orientation of the sealing assembly in an actual installation, there is shown in FIGS. 23 and 26 a ring seal assembly 10, constructed and assembled in accordance with the principles of the present invention. The assembly 10 comprises a retainer or retaining ring 12 surrounding, in circumferential fashion, an annular step seal or gasket 14. The gasket 14 comprises a center hole 16, and an annular body element 18. The retainer 12 is also annular in construction, comprising an annular body element 20 and a cylindrical inner wall 22 defining a center hole, into which the gasket 14 is inserted. Each of the retaining ring 12 and the gasket 14 are preferably fabricated of sheet steel or other suitable metal, having elastic characteristics and capable of being machined. In the embodiment shown in FIG. 26, the outer diameter (OD) of the retaining ring 12 is stepped, having a smaller OD portion 24 and a larger OD portion 26. A “removal groove” 27 is disposed on the smaller OD portion 24 of the retaining ring 12, for assisting in ensuring that the seal assembly is properly installed. The seal assembly 10 is so small that it is hard to see which side is larger (greater OD) without magnification, sometimes causing the installer to place the retainer in the counterbore in the wrong orientation. Essentially, this removal groove feature provides a visual identifiable feature, to assist the installer in ensuring the proper orientation of the seal assembly in the counterbore. Additionally, the groove serves as a place to hook a seal removal tool onto the retainer. Current design approaches require the person removing the seal assembly to exert radial pressure on the retainer wall, pulling the ring in an attempt to lift the assembly. If an insufficient amount of radial pressure is exerted, the assembly slips out of the removal tool. However, with the use of the groove 27 to receive and retain the removal tool, the operator can exert radial pressure as well as have a hook under the small ledge 27a created on the OD 24. This engagement with the ledge functions to prevent the seal assembly from slipping out of the removal tool.

A retainer ID groove 28 is disposed on the ring 12, within the larger OD portion 26. An outer chamfer 30 is disposed on each corner on the OD of the retainer 12. Inner chamfers 32 are disposed on the lower corners of the ID of the retainer 12, as well.

The gasket 14 comprises a substantially cylindrical ID 34, surrounding and defining the center hole 16. The OD of the gasket 14 comprises a smaller OD portion 36 and a larger OD portion 38. Between these two portions 36, 38 is disposed a load adjustment groove 40, or, in alternative embodiments, cylindrical bores or depressions 40.

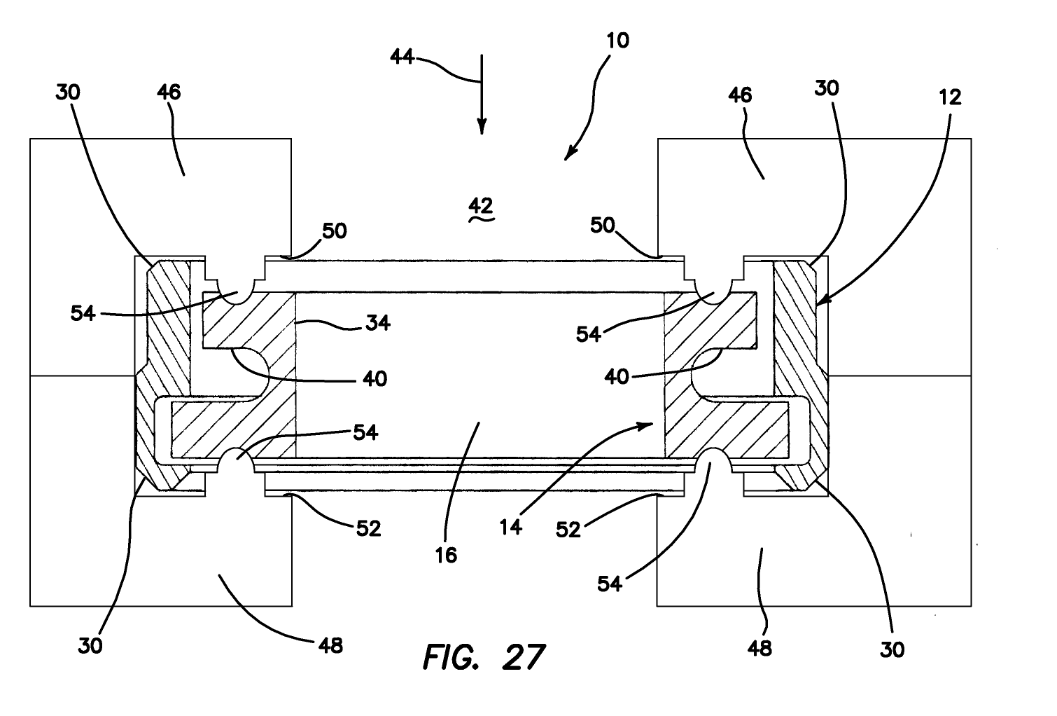

FIG. 27 illustrates the ring seal assembly 10 in an installed configuration. The seal assembly shown in FIG. 27 is somewhat modified, in that in the FIG. 27 embodiment the OD of the retaining ring 12 comprises the smaller OD portion 24 and the larger OD portion 26, but the smaller OD portion 24 does not include the removal groove 27 shown in FIG. 26. Either embodiment is within the scope of the present invention, the removal groove 27 being a desirable, but not always required, feature, depending upon application and other design considerations.

As illustrated in FIG. 27, the seal assembly 10 is disposed within a gas or fluid flow path 42, wherein the fluid flow moves in the direction of the arrow 44. Defining the fluid flow path 42 are a component 46 and a base block 48. A component counterbore 50 is machined into the component 46, while a complementary base block counterbore 52 is machined into the base block 48. It is noted that the outer chamfers 30 are advantageously designed to permit easy insertion of the retaining ring 12 into the counterbores 50, 52. The lower ends of the inner chamfers 32 extend into the ID of the ring 14 farther than the cylindrical inner wall portion 22, so that the retainer can be spread, using an angle tool, from the inside to facilitate ready insertion of the seal 14 into the center hole 22 of the retainer 12.

Upon installation of the seal assembly 10 into the flow path 42, the component 46 and base block 48 are compressed axially about the seal assembly 10, causing a sealing bead 54 on each of the blocks 46, 48 to engage the gasket 14. It is noted that, even when fully compressed, the retainer 12 remains spaced from the walls defining the counterbore 50, 52, as shown in FIG. 27, allowing continued play between the retainer and the counterbore.

It is important to note that the retainer 12 extends axially substantially above and below the seal 14. The reason for this is to ensure that, even when compressed, the upper and lower surfaces of the seal 14, which are highly polished, are protected from damage such as scratching, in order to preserve optimal seal integrity.

With reference now to FIGS. 5-21, various embodiments of each of the retainer 12 and gasket 14 are illustrated. It should be noted that any of the retainer embodiments and gasket embodiments may be employed, as shown in FIGS. 26 and 27, within the scope of the present invention, with a caveat that specific complementary features and dimensions of each element must be coordinated to fit together appropriately. The specific dimensions shown in the figures are exemplary only.

With respect to FIGS. 5-8, one embodiment of a retaining ring 12 is shown. As shown, a significant feature of the retaining ring 12 is the inclusion of a slot or gap 56 for the purpose of assisting fixation of the retainer 12 and gasket 14 within the counterbore. In this embodiment, the radial slot 56 passes completely through the wall of the retainer 12 for its entire axial length, thereby making it feasible to temporarily spread the slot (gap) 56 elastically. This spreading of the gap 56 enlarges the effective diameter of the center hole 22 sufficiently to accept the larger outside diameter portion 38 of the gasket 14, and to easily position the retainer inside diameter groove 28 over the larger outside diameter portion 38 of the gasket 14. This arrangement thus allows the gasket 14 to effectively float within the confines of the retainer 12.

As also shown throughout the various embodiments, chamfers 30 and 32 are preferably approximately 45 degrees, though that angle can be varied to a certain extent without substantially affecting ease of assembly.

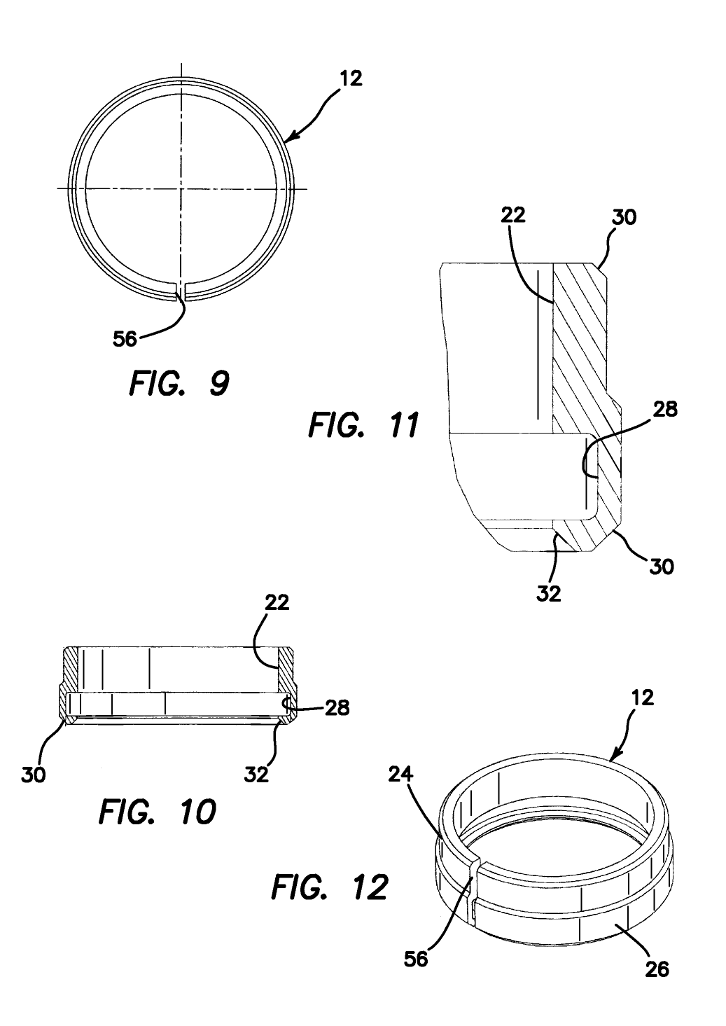

A somewhat modified embodiment of the retaining ring 12 is illustrated in FIGS. 9-12. The primary difference between this embodiment and that of FIGS. 5-8 is the utilization of a retaining ring having a stepped OD, comprised of the aforementioned smaller OD portion 24 and larger OD portion 26. This embodiment is the one shown, for illustration purposes, in FIG. 27.

FIGS. 13-17 illustrate one embodiment of the step seal or gasket 14 in accordance with the present invention. As shown, this embodiment comprises a smaller OD portion 36 and a larger OD portion 38, with a plurality of bores 40 spaced and disposed in each of the smaller OD portion 36 and the larger OD portion 38. These bores circumferentially alternate, as shown in FIG. 17, so that only one is shown in FIGS. 15 and 16.

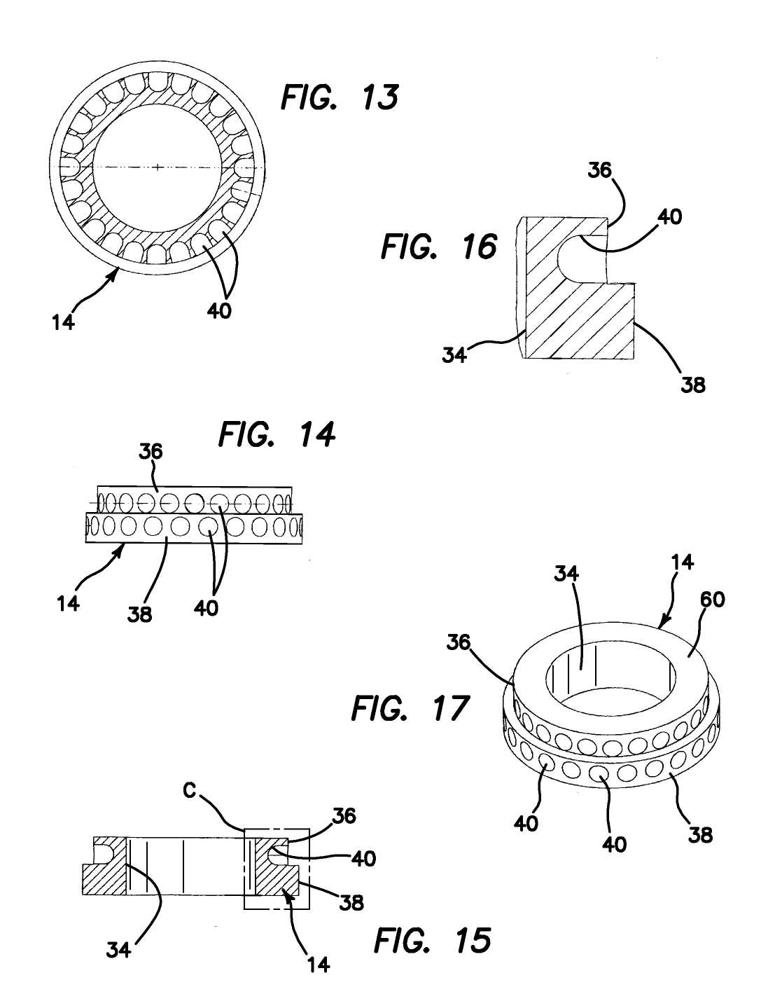

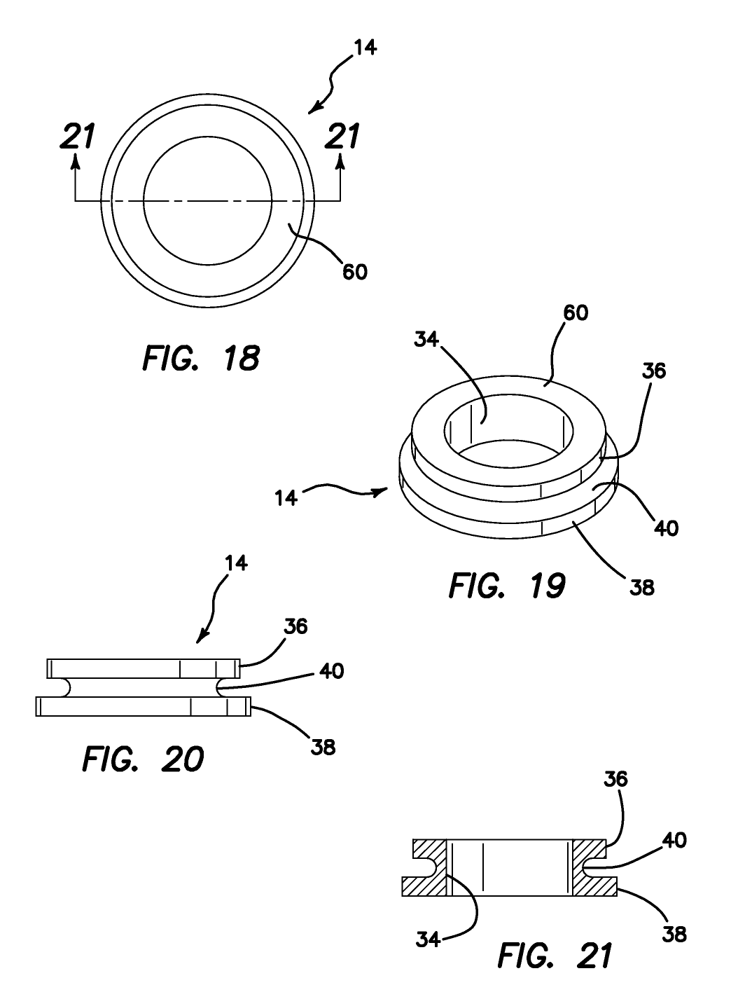

FIGS. 18-21 illustrate a somewhat modified embodiment of the step seal or gasket 14. The primary difference, other than with respect to certain dimensions, between the two embodiments is that in the FIG. 14 embodiment a single circumferential load displacement groove 40 is employed, instead of the bores 40 of FIGS. 9-13.

FIG. 22 illustrates yet another modified embodiment of the retaining ring 12. This embodiment is similar to the embodiment of FIG. 12, also shown in FIG. 27, differing only in the employment of a series of circumferentially spaced partial slots 58, rather than the full slot 56 shown in FIG. 12. As shown, these slots 58 only extend upwardly from the lower edge of the retainer 12 through the thicker circumferential section of the retainer wall, i.e. the OD 26. The partial slots 58 allow for the bottom half of the retainer 12 to spread open for receiving and protecting the seal 12. During the insertion of the seal, the bottom half of the retainer deforms to a slightly larger OD. Upon insertion into a counterbore, this enlarged OD will be forced inwardly and provide spring tension to hold the assembly in place.

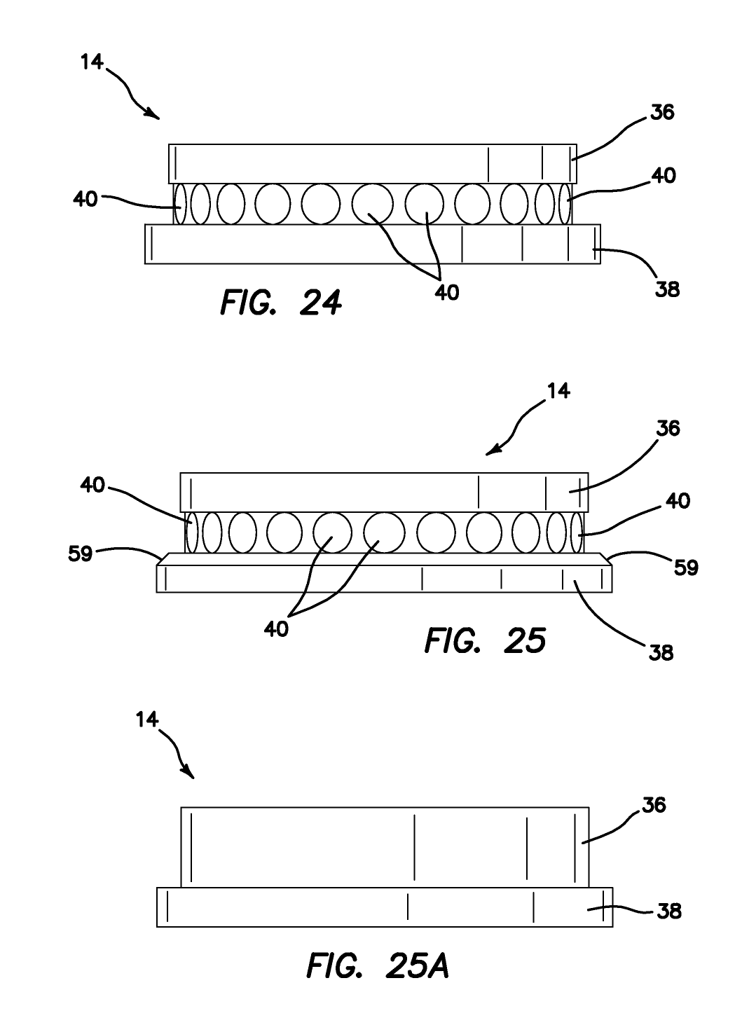

FIG. 24 illustrates yet another modified embodiment of the step seal or gasket 14. This embodiment is similar to that shown in FIGS. 13-17, but comprises only a single row of spaced bores 40, between the smaller ID portion 36 and the larger ID portion 38, rather than the dual rows of bores 40 shown in FIGS. 14 and 17.

FIG. 25 shows still another modified embodiment of the gasket 14, similar to that shown in FIG. 24, except for the addition of chamfer or angled step 59 about an upper circumferential edge of the larger ID portion 38. This angled step 59, preferably having an angle of about 45°, though this angle may be varied in accordance with design considerations, is intended to mate with the chamfer 32 on the retainer 14, upon assembly of the seal ring or gasket 14 within the retainer ring 12, to reduce the load on the assembly upon insertion.

Yet another modified embodiment of the gasket 14 is illustrated in FIG. 25a, wherein the OD of the seal is solid, having neither a groove or a series of bores for load adjustment. In certain embodiments, where such functionality is not required, this embodiment may be fabricated at substantially lower cost. This solid walled embodiment may employ the angled steps or chamfers 59, as shown in the FIG. 25 embodiment, if desired.

Referring once again to FIG. 27, it is noted that there is play between the seal and the retainer, even when assembled. The reason for this is to ensure that when the retainer compresses, it does not hit the seal, because otherwise it would not be able to be compressed to a dimension smaller than the counterbore, which would affect seal integrity. The split or slot 56,58 is a key to this feature, as it serves as the stop to control the amount of compression of the retaining ring 12. Upon compression, the ring 12 compresses until the two surfaces defining the split engage one another. Another notable feature is that the larger OD portion 38 of the stepped seal is captured top and bottom by the retainer 14 in its relaxed or pre-compression position. There is no interference between the retainer and the elastic response modifying portions (bores or load adjustment groove 40) of the seal.

As noted above, an important feature of the present invention is that both upper and lower sealing surfaces 60 (FIG. 26) of the seal 14 are recessed relative to the upper and lower edges of the retainer ring 12. In other words, there is a recess between respective opposed sealing surfaces 60 of the seal 14 and the upper and lower edges of the retainer ring 12. The purpose for this recess is to fully protect the polished sealing surfaces 60 of the seal ring 14 during handling.

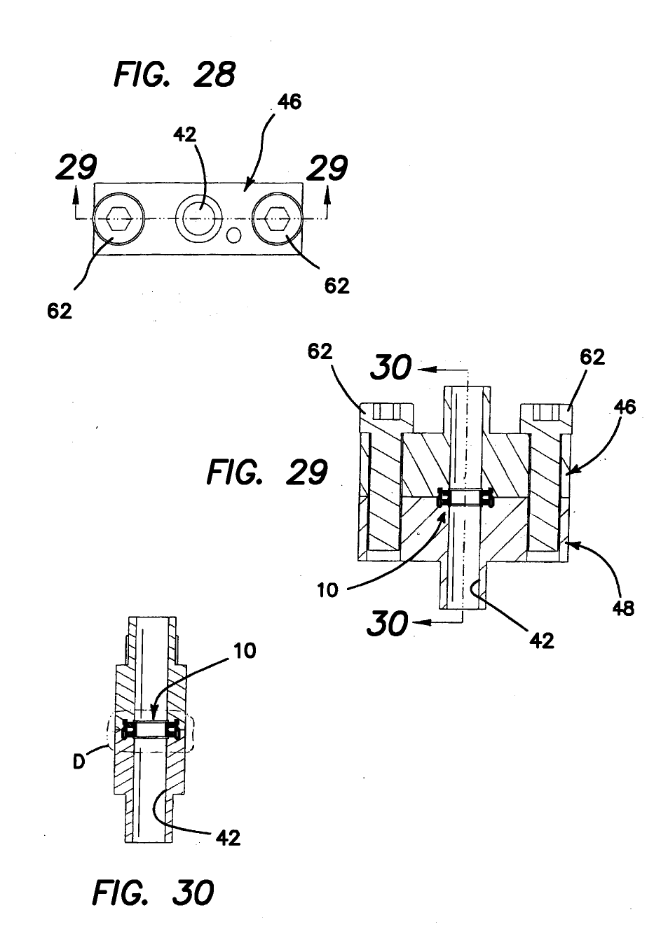

FIGS. 28-34 illustrate the seal assembly 10 in a typical sealing environment, wherein the fluid flow path 42 to be sealed is defined by the component 46 and base block 48 which are attached by bolts 62 or other suitable means. The seal 10 is adapted to be fitted within the space formed by the component counterbore 50 and corresponding base block counterbore 52, and to form a leak-tight fluid connection therein, via sealing beads 54. As is the case with FIGS. 26 and 27, any of the seal embodiments disclosed herein may be employed in the combination illustrated in FIGS. 29-34.

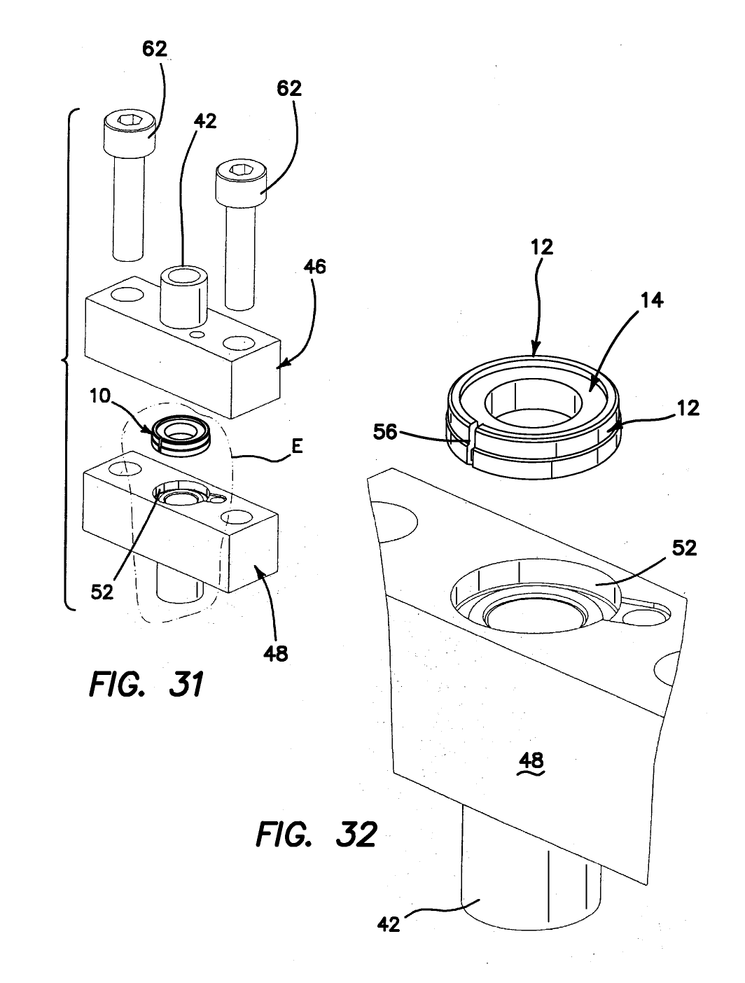

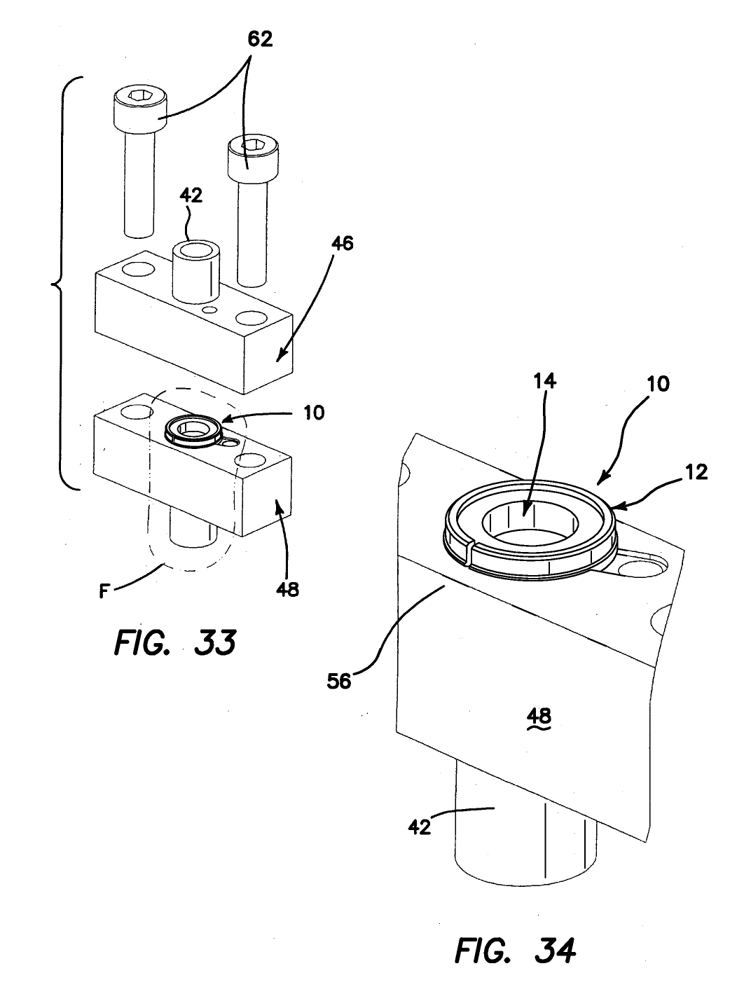

FIGS. 31-34 illustrate the process of snapping the metal seal assembly into the seal port counterbore 52 to install the seal. In FIGS. 31-32, the seal 10 is positioned above the counterbore 52. The next sequential step is illustrated in FIGS. 33-34, wherein the seal 10 is dropped into the counterbore 152. The two spring arms formed by the split 56, and comprising the retainer ring 12, fully wrap around the metal seal 14 and function to locate the metal seal at the center of the fluid path 42. The seal 14 retains itself in a centered orientation within the counterbore because of the tension of the spring-loaded retaining ring 12.

To remove the retainer assembly from the counterbore, a slight pressure is applied against one side of the exposed top half of the retainer, thereby closing the slit gap 56, and then applying a slight upward pressure to flip the assembly out of the counterbore. No tools are required.

Advantages of the present invention include the following. The innovative retainer design functions to force the seal to a centered orientation. The retainer ring is chamfered at both ends to allow for easy insertion. This allows the columnar retainer to easily bottom out in the connecting block into which it is inserted prior to closure. The larger diameter portion of the stepped seal is captured top and bottom by the retainer in its relaxed or pre-compression position. There is no interference between the retainer and the elastic modifying portions (groove or bores) of the seal. The stepped seal has bores or a groove disposed thereon for adjusting the elastic response of the seal, and the retainer is internally and externally contoured to the steps for uniform clearance and flexural response to closing forces.

While this invention has been described with respect to various specific examples and embodiments, it is to be understood that various modifications may be made without departing from the scope thereof. Therefore, the above description should not be construed as limiting the invention, but merely as an exemplification of preferred embodiments thereof and that the invention can be variously practiced within the scope of the following claims.

What is claimed is:

1. A ring seal assembly, comprising:
an annular metal seal having an ID, an OD, an upper sealing surface, and a lower sealing surface, wherein the OD comprises a larger OD portion and a smaller OD portion; and
an annular metal retaining ring comprising an outer wall having an ID and OD, wherein the ID of the retaining ring is sufficiently large to accommodate the OD of the annular metal seal within its boundaries;
the ID of the retaining ring having a groove disposed therein which is circumferentially arranged to receive the larger OD portion of the annular metal seal, the larger OD portion of the seal comprising metal and extending radially into the groove and the remaining ID portion of the retaining ring bounding the smaller OD portion of the seal.

2. The ring seal assembly as recited in claim 1, wherein the retaining ring is circumferentially compressible to a reduced circumferential size, and further wherein a gap exists between at least a portion of the circumference of said retaining ring and a corresponding portion of the circumference of said seal when the retaining ring is in a relaxed state and thus at its full natural circumferential size, thereby permitting the retaining ring to be compressed without impacting the seal.

3. The ring seal assembly as recited in claim 2, and further comprising a slit disposed through at least a portion of the retaining ring to provide the retaining ring with its circumferential compressibility.

4. The ring seal assembly as recited in claim 3, wherein said slit extends upwardly from a bottom edge of the retaining ring through only the larger OD portion of the retaining ring.

5. The ring seal assembly as recited in claim 4, and further comprising a plurality of said slits circumferentially spaced about said retaining ring.

6. The ring seal assembly as recited in claim 3, wherein the section of the retaining ring outer wall defining the larger ID portion is relatively thick and the section of the retaining ring outer wall defining the smaller ID portion is relatively thin.

7. The ring seal assembly as recited in claim 6, wherein the OD of the retaining ring is substantially uniform.

8. The ring seal assembly as recited in claim 6, wherein the OD of the retaining ring comprises a smaller OD portion and a larger OD portion.

9. The ring seal assembly as recited in claim 8, and further comprising a removal groove disposed in said smaller retaining ring OD portion.

10. The ring seal assembly as recited in claim 9, wherein the removal groove forms a radially-oriented ledge for assisting in removal of the assembly from a counterbore.

11. The ring seal assembly as recited in claim 1, wherein the OD of the seal comprises a load adjusting feature.

12. The ring seal assembly as recited in claim 11, wherein the load adjusting feature comprises a groove extending circumferentially about the OD of the seal.

13. The ring seal assembly as recited in claim 11, wherein the load adjusting feature comprises a plurality of circumferentially spaced bores.

14. The ring seal assembly as recited in claim 13, wherein said circumferentially spaced bores form a single row between the smaller OD portion and the larger OD portion of the seal.

15. The ring seal assembly as recited in claim 13, wherein said circumferentially spaced bores form a row on the smaller OD portion of the seal and a second row on the larger OD portion of the seal.

16. The ring seal assembly as recited in claim 1, and further comprising a chamfer on at least one inside corner of said retaining ring for easing insertion of the sealing member into the retaining member.

17. The ring seal assembly as recited in claim 16, and further comprising a second chamfer on at least one outside corner of said retaining ring.

18. The ring seal assembly as recited in claim 16, and further comprising a chamfer or angled step on the larger OD portion of the seal for engaging the chamfer on the retaining ring.

19. The ring seal assembly as recited in claim 1, wherein the assembly does not have any snap rings.

20. A ring seal assembly, comprising:
an annular seal member having an inner diameter (ID) and an outer diameter (OD), and having an axial hole defined by the ID for fluid passage;
an annular retaining member having an ID and an OD, the ID of the retaining member being larger than the OD of the seal member; and
a chamfer on at least one inside corner of said annular retaining member for easing insertion of the sealing member into the retaining member.

21. The ring seal assembly as recited in claim 20, wherein the OD of the seal member comprises a smaller OD portion and a larger OD portion and the ID of the retaining member comprises an axially cylindrical first portion and a second portion comprising a groove extending radially outwardly of the first portion for receiving and accommodating the larger OD portion of the seal, which extends radially outwardly into said groove.

22. The ring seal assembly as recited in claim 21, wherein in its assembled state, with the seal disposed within the ID of the retaining ring, there is a gap between the seal and the retaining ring about a portion of the circumference of the assembly, to thereby permit compression of the retaining ring without substantial contact of the retaining ring with the seal.

23. The ring seal assembly as recited in claim 21, wherein the OD of the retaining ring comprises a smaller OD portion and a larger OD portion.

24. The ring seal assembly as recited in claim 21, and further comprising a recess between an annular edge of the retaining ring and one of the upper and lower sealing surfaces of the sealing ring when the seal assembly is in an assembled state, the recess functioning to protect the one of the upper and lower sealing surfaces from inadvertent contact damage.

25. The ring seal assembly as recited in claim 24, and further comprising a second recess between an opposing annular edge of the retaining ring and the other of the upper and lower sealing surfaces of the sealing ring when the seal assembly is in the assembled state, to thereby protect the other of the upper and lower sealing surfaces from inadvertent contact damage.

26. The ring seal assembly as recited in claim 20, wherein the assembly does not have any snap rings.

27. A fluid coupling comprising:
a base block;
a component, wherein the component is assembled to the base block;
a fluid flow passage extending through the assembled base block and component;
a counterbore disposed in the fluid passage and extending radially outwardly into the assembled base block and component, each of said base block and component having a sealing bead extending into the counterbore for engaging a seal; and
a ring seal assembly disposed in said fluid flow passage, the ring seal assembly comprising:
an annular metal seal having an ID, an OD, an upper sealing surface, and a lower sealing surface, wherein the OD comprises a larger OD portion and a smaller OD portion; and
an annular metal retaining ring comprising an outer wall having an ID and OD, wherein the ID of the retaining ring is sufficiently large to accommodate the OD of the annular metal seal within its boundaries;
the ID of the retaining ring having a groove disposed therein which is circumferentially arranged to receive the larger OD portion of the annular metal seal, the larger OD portion of the seal comprising metal and extending radially into the groove and the remaining ID portion of the retaining ring bounding the smaller OD portion of the seal;
wherein the ring seal assembly is secured into the counterbore such that the sealing beads engage the annular metal seal to seal the joint between the base block and the component.

28. A method of assembling a resilient retaining ring and an annular seal, wherein the retaining ring comprises a chamfered edge, the method comprising:
engaging the seal against the chamfered edge to expand the retaining ring;
sliding the seal into engagement with a groove on an ID surface of the retaining ring; and
permitting the retaining ring to expand circumferentially to seat and center the seal.
